(19) United States
(12) Patent Application Publication
(10) Pub. No.: US 2026/0132049 A1
(43) Pub. Date: May 14, 2026

(54) METHOD FOR PRODUCING IRON OXIDE MAGNETIC PARTICLES, AND IRON OXIDE MAGNETIC PARTICLES FORMED THEREFROM

(71) Applicant: ZTI BIOSCIENCES CO., LTD., Daejeon (KR)

(72) Inventors: Hyung Seok CHANG, Suwon-si (KR); Yong Sun PARK, Seoul (KR); Ji Young RYU, Yongin-si (KR)

(21) Appl. No.: 19/118,747

(22) PCT Filed: Oct. 5, 2023
(86) PCT No.: PCT/KR2023/015327

§ 371 Date: Apr. 4, 2025

(30) Foreign Application Priority Data
Oct. 11, 2022 (KR) 10-2022-0129743

(51) Int. Cl. C01G 49/02

(52) U.S. Cl. CPC C01G 49/02; C01P 2002/85; C01P 2006/42

(57) ABSTRACT

The present disclosure provides: a method for producing iron oxide magnetic particles, the method including synthesizing an iron precursor by mixing an iron salt, at least one fatty acid salt selected from the group consisting of fatty acid salts including fatty acid salts having 4 to 25 carbon atoms, and at least one alcohol selected from the group consisting of alcohols having 1 to 5 carbon atoms, and then heating and washing the mixture to form an iron fatty acid complex, synthesizing iron oxide particles containing MX₁ₙ by mixing the synthesized iron precursor, MX₁ₙ, and at least one aliphatic alcohol selected from the group consisting of aliphatic alcohols having 6 to 25 carbon atoms, and heating the mixture, and forming iron oxide magnetic particles containing the synthesized iron oxide particles and MX₂ₙ by mixing the synthesized iron oxide particles into a solution containing AX₂ₙ, and replacing the X₁ₙ and X₂ₙ, and iron oxide magnetic particles formed from the method.

### TECHNICAL FIELD

The present disclosure relates to a method for producing iron oxide magnetic particles and iron oxide magnetic particles formed therefrom.

### BACKGROUND ART

Magnetic particles have been widely used in biomedical fields including cell labeling, magnetic resonance imaging (MRI), drug delivery, and hyperthermia. Among various types of magnetic particles, superparamagnetic iron oxide magnetic particles (iron oxide-based nanoparticles) have been widely studied in the biomedical fields due to high magnetic susceptibility and superparamagnetism.

In addition, since the magnetic particles have the characteristic of generating heat when applied with radiation or a magnetic field, the magnetic particles may also be used as contrast agents for magnetic resonance imaging (MRI), magnetic carriers for drug delivery in the field of nanomedicine, magnetic or radiation-based hyperthermia therapy, and the like.

In the diagnostic imaging field, iron oxide is a superparamagnetic contrast agent and has been proposed as a negative contrast agent. In order for the superparamagnetic iron oxide contrast agent to be used as an effective contrast agent, the contrast agent needs to be produced as a stable magnetic iron oxide solution having a high saturation magnetization and being small and uniform. The iron oxide solution is a colloidal dispersion solution of magnetic nanoparticles such as Fe₃O₄ or Fe₂O₃ and needs to be maintained in a liquid state even under a very strong magnetic field. However, pure superparamagnetic iron oxide magnetic particles aggregate well together due to strong hydrophobic attraction to form clusters, or are rapidly biodegraded when exposed to the biological environment, and thus not sufficiently stable, so that the original structure may change to alter their magnetic properties and have toxicity. On the other hand, iodine is proposed as a positive contrast agent, but when used at a high concentration to enhance the contrast effect, there is a problem of liver/renal toxicity, so that a formulation technology that increases the content per volume of a contrast medium has been introduced.

In the case of conventional radioactive diagnostic/therapeutic agents, it is difficult to be stored for long periods or distributed over long distances due to their short half-life. To this end, most medical institutions produce and use the radioactive diagnostic/therapeutic agents locally and daily as needed. However, when radioactive pharmaceuticals manufactured in this way are administered into the body, labeled radionuclides may be separated to cause side effects in other normal tissues.

### PRIOR ARTS

### Non-Patent Document

(Non-Patent Document 1) Non-Patent Document: Wust et al. Lancet Oncology, 2002, 3:487-497.

### DISCLOSURE

### Technical Problem

An object to be solved by the present disclosure is to provide a method for producing iron oxide magnetic particles which do not form clusters, maintain a small and uniform size, exhibit stable magnetic properties without changing the structure, and are not harmful to the human body, and to provide a production method capable of complementing a short half-life of radioactive elements.

### Technical Solution

In order to solve the object, an aspect of the present disclosure provides a method for producing iron oxide magnetic particles, the method including synthesizing an iron precursor by mixing an iron salt, at least one fatty acid salt selected from the group consisting of fatty acid salts including fatty acid salts having 4 to 25 carbon atoms, and at least one alcohol selected from the group consisting of alcohols having 1 to 5 carbon atoms, and then heating and washing the mixture to form an iron fatty acid complex, synthesizing iron oxide particles containing MX₁ₙ by mixing the synthesized iron precursor, MX₁ₙ, and at least one aliphatic alcohol selected from the group consisting of aliphatic alcohols having 6 to 25 carbon atoms, and heating the mixture, and forming iron oxide magnetic particles containing the synthesized iron oxide particles and MX₂ₙ by mixing the synthesized iron oxide particles into a solution containing AX₂ₙ, and replacing the X₁ₙ and X₂ₙ. Another aspect of the present disclosure provides iron oxide magnetic particles formed by the method for producing iron oxide.

### Advantageous Effects

According to the method for producing iron oxide magnetic particles according to the present disclosure, iron oxide magnetic particles are not aggregated well not to form clusters, may be produced with uniform particles having a size of several tens of nanometers or less, exhibit stable magnetic properties without changing a structure, are not harmful to the human body due to very low toxicity, and thus can be widely used in a biomedical field, such as a contrast agent for magnetic resonance imaging (MRI), a magnetic carrier for drug delivery in the field of nanomedicine, and magnetic or radiation-based hyperthermia therapy.

### DESCRIPTION OF DRAWINGS

FIG. 1 is a graph showing labeling efficiency and purity of ¹³¹I for iron oxide magnetic particles before and after a reaction in Example 1.

FIG. 2 is a photograph showing results of EDS analysis of iron oxide magnetic particles produced in the same manner as in Example 1, by replacing ¹³¹I with I.

FIG. 3 is a graph showing XPX results of iron oxide magnetic particles produced in the same manner as in Example 1, by replacing ¹³¹I with I.

### MODES

Hereinafter, various embodiments of the present disclosure will be described in detail with reference to the accompanying drawings. The present disclosure is not limited to specific embodiments, and it should be understood to include various modifications, equivalents, and/or alternatives to the embodiments of the present disclosure. In connection with the description of the drawings, similar reference numerals may be used for similar components.

In this specification, expressions such as “have,” “may have,” “include,” or “may include” refer to the presence of the corresponding feature (e.g., numerical value, function, operation, or component such as part), and does not exclude the presence of additional features.

In the present disclosure, the expression such as “A or B”, “at least one of A and/or B”, or “one or more of A and/or B” may include all possible combinations of items listed together. For example, “A or B”, “at least one of A and B”, or “at least one of A or B” may refer to all cases of (1) including at least one A, (2) including at least one B, or (3) including both at least one A and at least one B.

The expression of “configured to” used herein may be changed and used to, for example, “suitable for”, “having the capacity to”, “designed to”, “adapted to”, “made to” or “capable of”, depending on a situation. The term of “configured to (or set to)” may not necessarily mean “specially designed to”.

The terms used herein are used to illustrate only specific embodiments, and may not be intended to limit the scope of other embodiments. A singular expression may include a plural expression unless the context clearly indicates otherwise. The terms used herein, including technical or scientific terms, may have the same meaning as generally understood by those of ordinary skill in the art described in the present disclosure. The terms defined in a general dictionary among the terms used herein may be interpreted in the same or similar meaning as or to the meaning on the context of the related art, and will not be interpreted as an ideal or excessively formal meaning unless otherwise defined in the present disclosure. In some cases, even the terms defined in the present disclosure can not be interpreted to exclude the embodiments of the present disclosure.

The embodiments disclosed in the present disclosure are presented for explanation and understanding of the disclosed technical contents, and do not limit the scope of the present disclosure. Therefore, the scope of the present disclosure should be interpreted as including all changes or various other embodiments based on the technical idea of the present disclosure.

Hereinafter, a preferred embodiment of the present disclosure will be described in detail. Terms and words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

Therefore, the configurations of the embodiments described in the present specification are merely the most preferred embodiment of the present disclosure and are not intended to represent all of the technical ideas of the present disclosure, and thus, it should be understood that there are various equivalents and modifications capable of replacing the configurations at the time of this application.

Throughout the specification, when a part “includes” a component, unless otherwise specifically stated, it is meant to further include other components rather than excluding other components.

Hereinafter, the present disclosure will be described in detail.

A method for producing iron oxide magnetic particles according to an embodiment of the present disclosure includes steps of synthesizing an iron precursor by mixing an iron salt, at least one fatty acid salt selected from the group consisting of fatty acid salts including fatty acid salts having 4 to 25 carbon atoms, and at least one alcohol selected from the group consisting of alcohols having 1 to 5 carbon atoms, and then heating and washing the mixture to form an iron fatty acid complex, synthesizing iron oxide particles containing MX₁ₙ by mixing the synthesized iron precursor, MX₁ₙ, and at least one aliphatic alcohol selected from the group consisting of aliphatic alcohols having 6 to 25 carbon atoms, and heating the mixture, and forming iron oxide magnetic particles containing the synthesized iron oxide particles and MX₂ₙ by mixing the synthesized iron oxide particles into a solution containing AX₂ₙ, and replacing the X₁ₙ and X₂ₙ. Hereinafter, each step will be described in detail.

In the step of synthesizing the iron precursor, uniform iron oxide magnetic particles having sizes of several tens nanometers or less that are not aggregated well between molecules and do not form clusters may be produced by forming an iron fatty acid complex in which iron as a central atom is bound with at least one fatty acid salt selected from the group consisting of fatty acid salts including fatty acid salts having 4 to 25 carbon atoms.

In the step of synthesizing the iron precursor, the heating method is performed by mixing an iron salt, at least one fatty acid salt selected from the group consisting of fatty acid salts including fatty acid salts having 4 to 25 carbon atoms, and at least one alcohol selected from the group consisting of alcohols having 1 to 5 carbon atoms, and then heating the mixture from 25° C. to 50° C. to 60° C. at a heating rate of 2° C./min to 4° C./min, and may be achieved by a reaction at 50° C. to 60° C. for 4 to 5 hours. Preferably, after the heating reaction, the reactants are first separated using a separatory funnel. The first separated lower water layer may be discarded, and the reactants were further added with purified water, and then washed through a second separation step. More preferably, a step of heating the second separated and washed reactants again at 100° C. to 110° C. for 24 hours may further be performed.

In the step of synthesizing the iron precursor, the heating may accelerate a reaction between the iron salt and the fatty acid salt, resulting in facilitating the production of an iron fatty acid complex. The iron precursor may be synthesized by mixing the iron salt, at least one fatty acid salt selected from the group consisting of fatty acid salts having 4 to 25 carbon atoms and at least one alcohol selected from the group consisting of alcohols having 1 to 5 carbon atoms, rapidly heating the mixture at a heating rate of 2° C./min to 4° C./min, and then maintaining the mixture at the temperature at 50° C. to 60° C. for 4 to 5 hours within 5 to 10 minutes after mixing the reactants. At least one alcohol selected from the group consisting of alcohols having 1 to 5 carbon atoms may serve as a solvent when mixed.

In the step of synthesizing the iron precursor, the weight ratio of the iron salt and at least one fatty acid salt selected from the group consisting of fatty acid salts having 4 to 25 carbon atoms may be 1:3 to 4. Preferably, in the step of synthesizing the iron precursor, the weight ratio of the iron salt and at least one fatty acid salt selected from the group consisting of fatty acid salts having 4 to 25 carbon atoms may be 1:3.

In the step of synthesizing the iron oxide particles containing MX₁ₙ, an unsaturated hydrocarbon having 6 to 20 carbon atoms may be further included and mixed.

In the step of synthesizing the iron oxide particles containing MX₁ₙ, the unsaturated hydrocarbon having 6 to 20 carbon atoms may be hexene, heptene, octene, nonene, decene, undecene, dodecene, tridecene, tetradecene, pentadecene, hexadecene, heptadecene, octadecene, 1-octadecene, nonadecene, or icosene.

In the step of synthesizing the iron precursor, the iron salt may include at least one of anhydrides or hydrates of the iron salt.

The anhydride of the iron salt may include at least one selected from the group consisting of ferrous chloride (FeCl₂), ferric chloride (FeCl₃), ferrous fluoride (FeF₂), ferric fluoride (FeF₃), ferrous sulfate (FeSO₄), ferric sulfate (Fe₂ (SO₄)₃), iron acetate (Fe(CO₂CH₃)₂), and iron nitride (Fe(NO₃)₃), but is not limited thereto.

The hydrate of the iron salt may include at least one selected from the group consisting of ferrous chloride hydrate (FeCl₂·H₂O), ferric chloride hydrate (FeCl₃·H₂O), ferrous fluoride hydrate (FeF₂·H₂O), ferric fluoride hydrate (FeF₃·H₂O), ferrous sulfate hydrate (FeSO₄·H₂O), ferric sulfate hydrate (Fe₂(SO₄)₃·H₂O), iron acetate hydrate (Fe(CO₂CH₃)₂), and iron nitride hydrate (Fe(NO₃)₃·H₂O), but is not limited thereto.

Preferably, in the step of synthesizing the iron precursor, examples of the fatty acid salt having 4 to 25 carbon atoms may include at least one selected from the group consisting of butyrate, valerate, caproate, enanthate, caprylic acid, pelargonate, caprate, laurate, myristate, pentadecylate, acetate, palmitate, palmitoleate, margarate, stearate, oleate, vaccenate, linoleate, (9,12,15)-linolenate, (6,9,12)-linolenate, eleostearate, tuberculostearate, lacidate, arachidonate, behenate, lignocerate, nervonate, ceroterate, montanate, melissate and peptide salts containing one or more amino acids. These compounds may also be used alone or in the form of mixed salts of two or more types. More preferably, the fatty acid salt having 4 to 25 carbon atoms may be oleate, but is not limited thereto.

The metal ingredient of the fatty acid salt having 4 to 25 carbon atoms may include at least one selected from the group consisting of calcium, sodium, potassium, and magnesium.

In the step of synthesizing the iron precursor, examples of the alcohol having 1 to 5 carbon atoms may include at least one selected from the group consisting of methanol, ethanol, propanol, isopropanol, butanol, isobutanol, pentanol, ethylene glycol, propylene glycol, and diethylene glycol. More preferably, in the step of synthesizing the iron precursor, at least one alcohol selected from the group consisting of alcohols having 1 to 5 carbon atoms may be ethanol, but is not limited thereto.

The step of synthesizing the iron oxide particles containing MX₁ₙ is to synthesize a precursor before substituting MX₁ₙ with MX₂ₙ thereafter, and it is sufficient if the iron oxide contains MX₁ₙ, but specifically, the precursor may be prepared through the following process.

In the step of synthesizing the iron oxide particles containing MX₁ₙ, the method of heating the mixture may be performed by gradually increasing the temperature from 10° C. to 350° C. at a rate of 5° C./min to 15° C./min.

In the step of synthesizing the iron oxide particles containing MX in, the method of heating the mixture is a method for gradually increasing the temperature at a constant rate so as to have high dispersibility while maintaining small and uniform sizes of the iron oxide magnetic particles of several tens of nanometers or less. By the method of gradually increasing the temperature at the constant rate, the iron oxide magnetic particles may have an average particle diameter (d50) of 6 nm to 20 nm. More preferably, the average particle diameter may be 6 nm to 15 nm, 8 nm to 15 nm, or 8 nm to 12 nm. When the heating rate is less than 5° C./min or more than 15° C./min, the size of the iron oxide magnetic particles may be formed ununiformly, and the average particle diameter may be smaller than 6 nm or larger than 20 nm.

In the step of synthesizing the iron oxide particles containing MX₁ₙ, a weight ratio of the iron precursor and MX₁ₙ may be 1:0.001 to 0.1. Preferably, in the step of synthesizing the iron oxide particles containing MX₁ₙ, the weight ratio of the iron precursor and MX₁ₙ may be 1:0.005 to 0.05. In the step of synthesizing the iron oxide particles containing MX₁ₙ, a weight ratio of the iron precursor, MX₁ₙ and at least one aliphatic alcohol selected from the group consisting of aliphatic alcohols having 6 to 25 carbon atoms may be 1:0.001 to 0.1:2 to 5. When the weight ratio of the iron precursor and MX₁ₙ is less than or greater than the above range, the doping content of MX₁ₙ in the iron oxide particles containing MX₁ₙ may be relatively reduced. In addition, when the weight ratio of the iron precursor and at least one aliphatic alcohol selected from the group consisting of aliphatic alcohols having 6 to 25 carbon atoms is less than or greater than the above range, the particle sizes of the iron oxide magnetic particles containing MX₁ₙ may be formed ununiformly, and the average particle diameter may be smaller than 6 nm or larger than 20 nm.

In the step of synthesizing the iron oxide particles containing MX₁ₙ, at least one aliphatic alcohol selected from the group consisting of aliphatic alcohols having 6 to 25 carbon atoms may include at least one alcohol selected from the group consisting of oleyl alcohol, hexanol, heptanol, octanol, nonanol, decanol, undecanol, dodecanol, tridecanol, tetradecanol, pentadecanol, hexadecanol, heptadecanol, octadecanol, nonadecanol, icosanol, heneicosanol, docosanol, tricosanol, tetracosanol, pentacosanol, hexacosanol, cyclohexanol, cycloheptanol, cyclooctanol, cyclononanol, cyclodecanol, cycloundecanol, cyclododecanol, cyclotridecanol, cyclotetradecanol, cyclopentadecanol, cyclohexadecanol, cycloheptadecanol, cyclooctadecanol, cyclononadecanol, cycloicosanol, cyclohenicosanol, cyclodococosanol, phenol, methylphenol, ethylphenol, propylphenol, butylphenol, pentylphenol, hexylphenol, octylphenol, nonylphenol, cumylphenol, dimethylphenol, methylethylphenol, methylpropylphenol, methylbutylphenol, methylpentylphenol, diethylphenol, ethylpropylphenol, ethylbutylphenol, dipropylphenol, dicumylphenol, trimethylphenol, triethylphenol, and naphthol. More specifically, in the step of synthesizing the iron oxide particles containing MX₁ₙ, at least one aliphatic alcohol selected from the group consisting of aliphatic alcohols having 6 to 25 carbon atoms may be oleyl alcohol.

The step of forming the magnetic particles containing the iron oxide particles and MX₂ₙ may include dispersing the iron oxide particles containing MX₁ₙ in a hydrophobic solvent, and then adding and heating a solution containing AX₂ₙ to a hydrophilic solvent as a solvent or irradiating the solution with a microwave to replace X₁ₙ with X₂ₙ.

The M includes at least one selected from the group consisting of Cu, Sn, Pb, Mn, Ir, Pt, Rh, Re, Ag, Au, Pd, Os, Ta, Yb, Zr, Hf, Tb, Tm, Ce, Dy, Er, Eu, Ho, Fe, La, Nd, Pr, Lu, Sc, Sr, Y, Sm, Bi, Ra, Ac, Th, At, Co, As, At, Ga, mTc and In, the X₁ or X₂ includes at least one selected from the group consisting of F, Cl, Br, I, P, S, N and O, and the n may be an integer of 1 to 6.

The MX₁ₙ may include at least one selected from the group consisting of CuF, CuF₂, CuF₃, CuCl, and CuCl₂, and the MX₂ₙ may include at least one selected from the group consisting of CuBr, CuBr2, CuI, CuI₂, and CuI₃.

The A may be an alkali or alkaline earth element, and specifically, may include at least one selected from the group consisting of Li, Na, K, Ru, Cs, Fr, Be, Mg, Ca, Sr, Ba, and Ra.

The “iron oxide” may include at least one selected from the group consisting of iron oxides, for example, Fe₁₃O₁₉, Fe₃O₄ (magnetite), γ-Fe₂O₃ (maghemite), and αFe₂O₃ (hematite), β-Fe₂O₃ (beta phase), ε-Fe₂O₃ (epsilon phase), FeO (wustite), FeO₂ (iron dioxide), Fe₄O₅, Fe₅O₆, Fe₅O₇, Fe₂₅O₃₂, ferrite type, and delafossite, but is not limited thereto.

The particles containing the iron oxide particles and MX₂ₙ are magnetic and may amplify the contrast effect of iron oxide under conditions of relatively low alternating magnetic field strength and/or low frequency magnetic field or various radiation conditions.

In addition, the X₁ₙ or X₂ₙ may include a radioisotope or a radioisotope mixture of X. Specifically, the radioisotope refers to a compound in which one or more atoms are replaced by atoms having the same atomic number, but having an atomic mass or mass number different from the atomic mass or mass number usually found in nature. Examples of isotopes suitable to be included in the compound of the present disclosure include isotopes of fluorine, such as ¹⁸F; isotopes of chlorine, such as ³⁶Cl; isotopes of bromine, such as ⁷⁵Br, ⁷⁶Br, ⁷⁷Br and ⁸²Br; and isotopes of iodine, such as ¹²³I, ¹²⁴I, ¹²⁵I, and ¹³¹I, alone or in combination.

The isotopes of F, Br, Cl, and I, which do not emit radiation in nature, have half-lives of only tens of minutes to several days. Therefore, when iron oxide magnetic particles containing radioactive isotopes are produced in advance, the emission rate of radiation may be significantly lowered at the time when actual demand is needed because the time has passed during a distribution stage. In particular, since the iron oxide magnetic particles of the present disclosure may be delivered to various medical institutions and administered to patients, the reduction in radiation efficiency may be a very important issue.

The step of forming the iron oxide magnetic particles containing the synthesized iron oxide particles and MX₂ₙ by mixing the synthesized iron oxide particles in the solution containing AX₂ₙ and substituting the X₁ₙ and X₂ₙ is to form iron oxide magnetic particles containing the iron oxide particles and MX₂ₙ by reacting the iron oxide particles containing MX₁ₙ with AX₂ₙ to induce a chemical reaction of substituting X₁ₙ and X₂ₙ. Here, the chemical reaction may also be carried out through a heating process, or a process time may be shortened by using a microwave irradiation process.

Here, the containing of the iron oxide particles and MXₙ (MX₁ₙ or MX₂ₙ) may mean that physical or chemical bonds are formed between the iron oxide particles and MXₙ. Specifically, MXₙ may be disposed between iron oxide particles, or MXₙ may be bound to the iron oxide particles through hydrogen bonding, or the MXₙ may be formed on the surface of the iron oxide particles by introducing a general coating method, or by introducing a doping method such as a diffusion process or an ion implantation process, or the iron oxide particles may be formed inside MXₙ so as to form a shell structure.

The hydrophobic solvent may include at least one selected from the group consisting of toluene, hexane, octane, heptane, tetradecane, chloroform, methyl chloride, butyl carbitol acetate, ethyl carbitol acetate, α-terpineol, and acetone. Since the iron oxide particles containing MX₁ₙ have a hydrophobic surface, it is preferable to use the hydrophobic solvent to maximize the dispersibility between the iron oxide particles containing MX₁ₙ while easily dispersing the iron oxide particles. In terms of compatibility with the solution containing AX₂ₙ, in the hydrophilic solvents to be applied thereafter, toluene, hexane and chloroform are preferable.

In the dispersion, it is preferable to adjust the weight ratio of the iron oxide particles containing MX₁ₙ and the hydrophobic solvent to 1:200 to 700. When the weight ratio is less than the range, the dispersibility of iron oxide particles containing MX₁ₙ may be deteriorated, and a subsequent substitution process may not be easily performed. When the weight ratio is greater than the range, the energy of the process of heating or microwave irradiation may not be transferred to the iron oxide particles containing MX₁ₙ due to the excessive solvent content.

When the weight ratio is less than the range, intervals between particles in the solvent containing MX₁ₙ may be close to cause a decrease in dispersibility and agglomeration, making it difficult to perform the subsequent substitution process. When the weight ratio is greater than the range, the energy at the time of heating or microwave irradiation may not be transferred to the iron oxide particles containing MX In due to the excessive solvent content.

The hydrophilic solvent may include purified water, glycerol, methanol, and ethanol, and it is preferable to use deionized water as the purified water.

The particles produced through the step of synthesizing the iron oxide particles containing MX₁ₙ may be mixed and processed in a solution containing X₂ₙ (a solution containing AX₂ₙ) having a short half-life that is just produced locally to emit the highest amount of radiation, after a long-term storage or long-term distribution process (e.g., air transportation, etc.).

According to the production method, the amount of radiation that may be lost during long-term distribution process (or decay according to the half-life of the radioactive element) may be easily replaced on-site by substitution. In addition, rather, by utilizing the substitution method, the ratio of X₂ₙ bound to iron oxide may be significantly increased compared to particles formed from conventional production methods.

In addition, as another example of the present disclosure, it may be very easy to include different isotopes in radioactive isotopes to be bound to the iron oxide magnetic particles depending on a used place. For example, since ¹²⁴I as X₂, may be used for PET imaging diagnosis, ¹²⁵I may be used for SPECT imaging diagnosis, and ¹³¹I may be used for thyroid cancer treatment, iron oxide particles containing a iron precursor and MX₁ₙ are first produced, and then, through a distribution process, the final iron oxide magnetic particles may be produced by easily substituting X₂ₙ (in which half-life of the radioisotope has not yet expired) held by a medical institution that intends to apply the corresponding particles depending on a used place.

Specifically, since ¹³¹I used in thyroid cancer treatment has a very short half-life of 8 days, rather than producing and distributing magnetic particles containing iron oxide particles and Cu¹³¹I, iron oxide particles containing CuF₂ (¹⁹F, not a radioactive isotope) are first produced, and then the iron oxide particles containing CuF₂ are mixed and reacted in a solution containing Na¹³¹I to substitute ¹³¹I and F, so that locally produced ¹³¹I (with much left half-life) may bind to the iron oxide particles. From these results, iron oxide magnetic particles containing iron oxide particles and Cu¹³¹I may be directly applied to patients at a medical site.

In particular, according to one embodiment of the present disclosure, since the iron oxide particles containing MX₁ₙ have a hydrophobic surface, it is preferable to use the hydrophobic solvent, in order to maximize the dispersibility between the iron oxide particles containing MX₁ₙ while easily dispersing the iron oxide particles. In order to further facilitate the mixing with the solution containing AX₂ₙ in the hydrophilic solvent to be applied below, a process of mixing a hydrophilic coating compound having surfactant properties may be included by including both hydrophilic and hydrophobic parts in a molecular structure.

Specifically, when the iron oxide particles containing MX₁ₙ are dispersed in a hydrophobic solvent and then the process is performed by adding only a solution containing AX₂ₙ to a hydrophilic solvent as a solvent, it may be difficult to mix the hydrophilic and hydrophobic parts. The hydrophilic coating compound may be introduced to increase the solubility of iron oxide particles containing MX₁ₙ in a hydrophilic solvent and to enhance stabilization. Due to the introduction of the hydrophilic coating compound, it is possible to secure a higher substitution rate of X₂ₙ of the finally obtained iron oxide particles and iron oxide magnetic particles containing MX₂ₙ.

In the step of forming the iron oxide magnetic particles containing the iron oxide particles and MX₂ₙ, the iron oxide magnetic particles may be formed by further containing a hydrophilic coating compound and a targeting material.

Specifically, the forming of the iron oxide magnetic particles by further including the hydrophilic coating compound and the targeting material may be performed by mixing the hydrophilic coating compound and the targeting material simultaneously with heating or microwave irradiation when forming the iron oxide magnetic particles containing the iron oxide particles and MX₂ₙ, or by mixing the hydrophilic coating compound and the targeting material after heating or microwave irradiation. In addition, the process of the present disclosure may be introduced to provide at least a portion of the surface of the finally obtained iron oxide particles coated with a hydrophilic or charged ligand or polymer, and may be introduced to enhance targeting or penetration to specific cells such as cancer cells.

Such a hydrophilic coating compound may preferably be biocompatible and may include, for example, at least one selected from the group consisting of polyethylene glycol, polyethylene amine, polyethylene imine, polyacrylic acid, polymaleic anhydride, polyvinyl alcohol, polyvinylpyrrolidone, polyvinyl amine, polyacrylamide, polyethylene glycol, phosphoric acid-polyethylene glycol, polybutylene terephthalate, polylactic acid, polytrimethylene carbonate, polydioxanone, polypropylene oxide, polyhydroxyethyl methacrylate, starch, dextran derivatives, sulfonic acid amino acid, sulfonic acid peptide, silica, polypeptide, dipalmitoyl phosphatidylcholine (DPPC), 1,2-dipalmitoyl-sn-glycero-3-phosphoglycerol (DPPG), phosphatidylglycerol (PG), phosphatidylcholine (PC) and DSPE-PEG2000-maleimide, but is not limited thereto. If necessary, a peptide or protein containing folate, transferrin or RGD may be used as the targeting material when targeting cancer cells. Hyaluronidase or collagenase may be used as the targeting material to enhance penetration into cells. In addition, the targeting material may be prostate specific membrane antigen (PSMA) antibody or fragments thereof, PSMA peptide, scFv antibody fragment, biotin, folic acid, mannose, glucose, and galactose, but is not limited thereto.

In one specific example, the iron oxide magnetic particles may contain MX₂ₙ in a weight ratio of 1:0.001 to 0.1, preferably 1:0.01 to 0.05, based on the iron oxide particles, but is not limited thereto (the ratio is specified based on the result of inductively coupled plasma (ICP) mass spectroscopy, which is a metal content analysis device). By being included within the range, it is possible to secure excellent specific loss power, and also to secure a high temperature change under an external alternating magnetic field or during radiation.

In one specific example, the iron oxide magnetic particles may have an average particle diameter (d50) of 6 nm to 20 nm. The size of the diameter may be adjusted depending on a method of administration, a position of administration, and an organ to be diagnosed. For example, when the diameter is 15 nm or less, intravenous injection may be preferable, and when the diameter is 15 nm or more, intralesional or intratumor injection may be preferable.

In addition, the present disclosure provides iron oxide magnetic particles formed by the production method.

In the method for producing the iron oxide magnetic particles, parts by weight of the components at each step are as follows.

In the step of synthesizing the iron precursor by forming the iron fatty acid complex, parts by weight of each component are based on 10 to 20 parts by weight of the iron salt. In the step of synthesizing the iron precursor by forming the iron fatty acid complex, 30 to 40 parts by weight of at least one fatty acid salt selected from the group consisting of fatty acid salts having 4 to 25 carbon atoms, and 10 to 100 parts by weight of an alcohol having 1 to 5 carbon atoms may be included based on 10 to 20 parts by weight of the iron salt.

In the step of synthesizing the iron oxide particles containing MX₁ₙ, parts by weight of each component are based on 1 to 10 parts by weight of the iron precursor. In the step of synthesizing the iron oxide particles containing MX₁ₙ, 0.001 to 0.01 parts by weight of MX₁ₙ and 1 to 10 parts by weight of at least one aliphatic alcohol selected from the group consisting of aliphatic alcohols having 6 to 25 carbon atoms may be included based on 1 to 10 parts by weight of the iron precursor.

In the step of forming the iron oxide magnetic particles containing the iron oxide particles and MX₂ₙ, it is preferable that the parts by weight of each component is a sufficient amount to be added so that X₂, and X₁ₙ may be mutually substituted in the iron oxide particles containing MX₁ₙ and AX₂ₙ.

Hereinafter, Examples and the like will be described in detail to assist the understanding of the present disclosure. However, these Examples according to the present disclosure may be modified in various other forms, and the scope of the present disclosure should not be construed as being limited to the following Examples. These Examples of the present disclosure are provided to more fully explain the present disclosure to those of ordinary skill in the art.

### EXAMPLES AND COMPARATIVE EXAMPLES

### Example 1

### Synthesis of Iron Precursor by Forming Iron-Oleic Acid Complex (S1)

16.218 g of FeCl₃·6H₂O, 54.78 g of sodium oleate, 224 ml of hexane, 120 ml of ethanol, and 90 ml of deionized water were mixed and heated from 25° C. to 50° C. at a heating rate of 2.5° C./min for 10 to 15 minutes, and then stirred and reacted while maintaining the temperature at 50° C. for 4 hours. After cooling the reaction solution to room temperature, a transparent lower layer was removed using a separatory funnel, 100 ml of water was mixed with a brown upper organic layer, shaken, and the lower water layer was removed again. This process was repeated 3 times. The remaining brown organic layer was transferred to a beaker and heated at 110° C. for 4 hours to evaporate hexane.

### Synthesis of Iron Oxide Particles Containing CuF₂ (S2)

4.5 g (5 mmol) of the iron precursor prepared above (also called iron-oleic acid complex) and 0.0305 g (0.3 mmol) of CuF₂ were added and mixed with 17 g (53.8 mmol) of oleyl alcohol and 15 ml of 1-octadecene. The mixture solution was placed in a round bottom flask and gas and moisture were removed in a vacuum at 90° C. for about 30 minutes. Nitrogen was injected and the temperature was increased to 200° C. Thereafter, the temperature was increased to 320° C. at a rate of 10° C./min and the reaction was performed for 30 minutes. After cooling the reaction solution, the reaction solution was transferred to a 50 ml conical tube, injected with 30 ml of ethanol and hexane at a ratio of 2:1, and then centrifuged to precipitate the particles. The precipitated particles were washed with 10 ml of hexane and 5 ml of ethanol, and the obtained precipitate was dispersed in toluene or hexane. The size of the produced particles was 6 nm.

Substitution of Iron Oxide Particles Containing CuF₂ with Na¹³¹I (S3)

14.6 mg of iron oxide particles containing CuF₂ obtained above were dispersed in 1.6 mL of toluene (specific gravity: 1.5), added with 0.2 mL of acetonitrile and 3 mCi (175 μg) of Na¹³¹I in a 250 mL vial, and operated in a microwave at 1000 W for 10 minutes.

After removing the solution using an evaporator, 3 ml of deionized water was added and dispersed by sonication for 5 minutes. After dispersion, ethanol and deionized water were added in a 2:8 ratio to Amicon 100 k and washed using centrifugation (5,000 rpm, 5 m). The result was washed again by adding deionized water to Amicon 100 k and using centrifugation (5,000 rpm, 5 m) to obtain iron oxide magnetic particles containing Cu¹³¹I.

### Example 2

Substitution of Iron Oxide Particles Containing CuF₂ with Na¹³¹I, Coating with Lipid PEG and Synthesis of Folate (S4)

14.6 mg of iron oxide magnetic particles containing CuF₂ obtained in Example 1 were dispersed in 1.6 mL of toluene (specific gravity: 1.5), added with 0.2 mL of acetonitrile and 3 mCi (175 μg) of Na¹³¹I in a 250 mL vial, operated in a microwave at 2.4 GHz at 1000 W for 1 minutes, and then added with 180 mg of DSPE-PEG2000 (1,2-distearoyl-sn-glycero-3-phosphoethanolamine-N-[methoxy (polyethylene glycol)-2000)), 10 mg of DSPE-PEG2000 folate, 1.6 mL of deionized water, and 0.2 mL of 1 M NaCl in a 50 mL vial and operated in a microwave at 1000 W for 10 minutes.

After removing the solution using an evaporator, 3 ml of deionized water was added and dispersed by sonication for 5 minutes. After dispersion, ethanol and deionized water were added in a 2:8 ratio to Amicon 100 k and washed using centrifugation (5,000 rpm, 5 min). The result was washed again by adding deionized water to Amicon 100 k and using centrifugation (5,000 rpm, 5 m) to obtain iron oxide magnetic particles.

### Example 3

Final iron oxide magnetic particles were obtained in the same manner as in Example 1, except that 16.218 g of sodium oleate was mixed in step S1.

### Example 4

Final iron oxide magnetic particles were obtained in the same manner as in Example 1, except that 81.09 g of sodium oleate was mixed in step S1.

### Example 5

Final iron oxide magnetic particles were obtained in the same manner as in Example 1, except that 4.5 g (5 mmol) of an iron-oleic acid complex and 0.0061 g (0.06 mmol) of CuF₂ were mixed in step S2.

### Example 6

Final iron oxide magnetic particles were obtained in the same manner as in Example 1, except that 4.5 g (5 mmol) of an iron-oleic acid complex and 0.01525 g (0.15 mmol) of CuF₂ were mixed in step S2.

### Example 7

Final iron oxide magnetic particles were obtained in the same manner as in Example 1, except that 4.5 g (5 mmol) of an iron-oleic acid complex and 0.04575 g (0.45 mmol) of CuF₂ were mixed in step S2.

### Example 8

Final iron oxide magnetic particles were obtained in the same manner as in Example 2, except that 16.218 g of sodium oleate was mixed in step S1.

### Example 9

Final iron oxide magnetic particles were obtained in the same manner as in Example 2, except that 81.09 g of sodium oleate was mixed in step S1.

### Example 10

Final iron oxide magnetic particles were obtained in the same manner as in Example 2, except that 4.5 g (5 mmol) of an iron-oleic acid complex and 0.0061 g (0.06 mmol) of CuF₂ were mixed in step S2.

### Example 11

Final iron oxide magnetic particles were obtained in the same manner as in Example 2, except that 4.5 g (5 mmol) of an iron-oleic acid complex and 0.01525 g (0.15 mmol) of CuF₂ were mixed in step S2.

### Example 12

Final iron oxide magnetic particles were obtained in the same manner as in Example 2, except that 4.5 g (5 mmol) of an iron-oleic acid complex and 0.04575 g (0.45 mmol) of CuF₂ were mixed in step S2.

### Comparative Example 1

Final iron oxide magnetic particles were obtained in the same manner as in Example 1, except that 162.18 g of sodium oleate was mixed in step S1.

### Comparative Example 2

Final iron oxide magnetic particles were obtained in the same manner as in Example 1, except that 4.5 g (5 mmol) of an iron-oleic acid complex and 0.00305 g (0.03 mmol) of CuF₂ were mixed in step S2.

### Comparative Example 3

Final iron oxide magnetic particles were obtained in the same manner as in Example 1, except that 4.5 g (5 mmol) of an iron-oleic acid complex and 0.061 g (0.6 mmol) of CuF₂ were mixed in step S2.

### Comparative Example 4

Final iron oxide magnetic particles were obtained in the same manner as in Example 2, except that 162.18 g of sodium oleate was mixed in step S1.

### Comparative Example 5

Final iron oxide magnetic particles were obtained in the same manner as in Example 2, except that 4.5 g (5 mmol) of an iron-oleic acid complex and 0.00305 g (0.03 mmol) of CuF₂ were mixed in step S2.

### Comparative Example 6

Final iron oxide magnetic particles were obtained in the same manner as in Example 2, except that 4.5 g (5 mmol) of an iron-oleic acid complex and 0.061 g (0.6 mmol) of CuF₂ were mixed in step S2.

### EXPERIMENTAL EXAMPLES

### Experimental Example 1: Analysis of Temperature Change Under External Alternating Magnetic Field

The particles produced in Examples and Comparative Examples above were experimented for self-induced heating ability. Examples and Comparative Examples were diluted in deionized water to a concentration of 20 mg/ml, respectively, and an alternating magnetic field was applied to measure temperature changes using a thermocouple (OSENSA, Canada). (Used AC frequency and magnetic field strength: f=108.7 kHz, H=11.4 kA/m). The results were shown in Table 1 below.

A system heated by inducing an AC magnetic field consisted of four main subsystems: (a) a variable frequency and amplitude sine wave function generator (20 MHz Vp-p, TG2000, Aim TTi, USA), (b) a power amplifier (1200 W DC Power Supply, QPX1200SP, Aim TTi, USA), (c) an induction coil (turns: 17, diameter: 50 mm, height: 180 mm) and a magnetic field generator (Magnetherm RC, nanoTherics, UK), and (d) a temperature change thermocouple (OSENSA, Canada).

TABLE 1

| | Temperature reached |
|---|---|
| | per unit time (standard: |
| | 1 minute) Measurement |
| | start at 25° C. |
| Example 1 | 76 |
| Example 2 | 80 |
| Example 3 | 55 |
| Example 4 | 43 |
| Example 5 | 58 |
| Example 6 | 65 |
| Example 7 | 52 |
| Example 8 | 58 |
| Example 9 | 51 |
| Example 10 | 65 |
| Example 11 | 73 |
| Example 12 | 61 |
| Comparative Example 1 | 35 |
| Comparative Example 2 | 31 |
| Comparative Example 3 | 28 |
| Comparative Example 4 | 43 |
| Comparative Example 5 | 35 |
| Comparative Example 6 | 33 |

### Experimental Example 2: Measurement of Specific Loss Power

Since the heating value of particles varied depending on physical and chemical properties and the strength and frequency of an external alternating magnetic field, in most research results, the heating ability of the particles was represented as SLP and ILP. SLP represents lost electromagnetic power per mass unit, expressed in watts per kilogram. Thermal treatment effects between particles are able to be compared by converting the SLP value into an ILP value using Equation [ILP=SLP/(fH₂)] because the conditions of f (frequency) and H (magnetic field strength) may be different for each experiment.

SLP was measured using an AC magnetic field generator (Magnetherm RC, Nanotherics) with a pickup coil and an oscilloscope-controlled series resonant circuit. The SLP was measured under adiabatic conditions of f=108.7 kHz and H=11.4 kA/m, and the temperature was measured using a fiber-optic IR probe.

ILP was measured by adjusting the particles of Examples and Comparative Examples to a concentration of 20 mg/ml. The results were shown in Table 2 below.

TABLE 2

| | ILP measurement |
|---|---|
| Example 1 | 8.75 |
| Example 2 | 9.50 |
| Example 3 | 5.57 |
| Example 4 | 4.34 |
| Example 5 | 5.88 |
| Example 6 | 6.83 |
| Example 7 | 4.99 |
| Example 8 | 5.88 |
| Example 9 | 4.83 |
| Example 10 | 6.83 |
| Example 11 | 8.35 |
| Example 12 | 6.41 |
| Comparative Example 1 | 1.37 |
| Comparative Example 2 | 1.21 |
| Comparative Example 3 | 1.09 |
| Comparative Example 4 | 1.68 |
| Comparative Example 5 | 1.37 |
| Comparative Example 6 | 1.29 |

### Experimental Example 3: Microwave Stability Analysis of Iron Oxide Magnetic Particles

The particles of Examples, Comparative Examples, and a control group were irradiated for 15 minutes each using a microwave device manufactured by CEM, USA, under conditions of 2,400 to 2,500 MHz and 1,000 W, respectively. After microwave irradiation, the collapse of the particles was confirmed by measuring the content of halogen elements on a prodigy High Dispersion ICP measurement device equipped with a halogen option from A Teledyne Leeman Labs. The results were shown in Table 3.

TABLE 3

| | Measured halogen elements |
|---|---|
| Example 1 | 5 |
| Example 2 | 8 |
| Example 3 | 16 |
| Example 4 | 18 |
| Example 5 | 14 |
| Example 6 | 12 |
| Example 7 | 17 |
| Example 8 | 14 |
| Example 9 | 15 |
| Example 10 | 12 |
| Example 11 | 10 |
| Example 12 | 16 |
| Comparative Example 1 | 25 |
| Comparative Example 2 | 27 |
| Comparative Example 3 | 30 |
| Comparative Example 4 | 23 |
| Comparative Example 5 | 25 |
| Comparative Example 6 | 27 |
| Control group 1 (iron oxide Fe₃O₄) | 0 |
| Control group 2 (iron oxide-KI | 65 |
| 6 wt % doping) | |
| Control group 3 (iron oxide-MgI₂ | 57 |
| 6 wt % doping) | |

### Experimental Example 4: Measurement of Radiation Dose of Iron Oxide Magnetic Particles

The radiation dose (μCi) was confirmed by measuring gamma rays per 1 mg of Fe of each iron oxide magnetic particle using a gamma-ray counter (Gamma Counter, 1480 Wizard 3) manufactured by Perkin Elmer, USA, which was a device capable of measuring ¹³¹I radiation dose of the iron oxide magnetic particles of Examples, Comparative Examples, and control group. Accordingly, the binding strength of ¹³¹I could be confirmed. The results were shown in Table 4.

TABLE 4

| | Radiation dose (μCi)/Fe 1 mg |
|---|---|
| Example 1 | 100 |
| Example 2 | 103 |
| Example 3 | 69 |
| Example 4 | 59 |
| Example 5 | 72 |
| Example 6 | 88 |
| Example 7 | 65 |
| Example 8 | 73 |
| Example 9 | 62 |
| Example 10 | 89 |
| Example 11 | 95 |
| Example 12 | 85 |
| Comparative Example 1 | 30 |
| Comparative Example 2 | 28 |
| Comparative Example 3 | 25 |
| Comparative Example 4 | 34 |
| Comparative Example 5 | 31 |
| Comparative Example 6 | 29 |

### Experimental Example 5: Measurement of ¹³¹I Labeling Efficiency and Purity for Iron Oxide Magnetic Particles

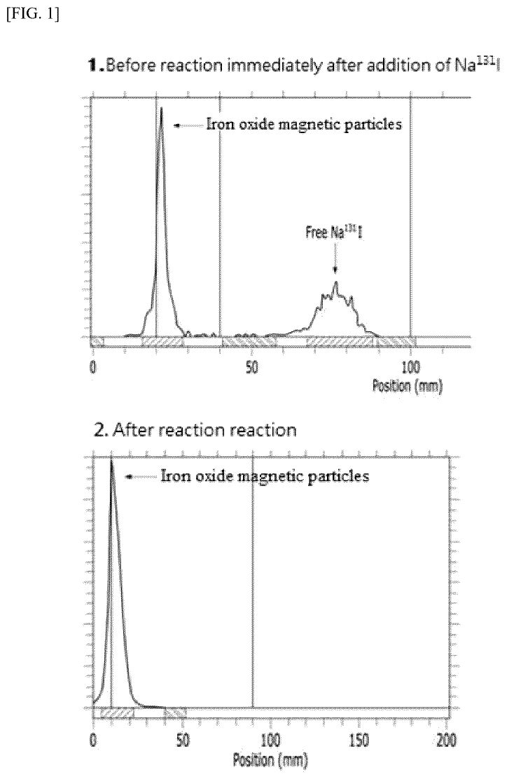

To measure the labeling efficiency and purity of ¹³¹I for the iron oxide magnetic particles of Example 1 above, iron oxide magnetic particles labeled with ¹³¹I were spotted on a silica TLC plate (TLC silica gel 60 F254) from Supelco. Co., Ltd. and developed using acetone (100%) as a solvent. Then, the radiolabeling efficiency and purity of each 131I-labeled iron oxide magnetic particle before and after the reaction were confirmed immediately after the addition of Na¹³¹I using a Radio-TLC Imaging Scanner (AR-2000) from Eckert & Ziegler. The results were shown in FIG. 1.

In Experimental Examples 6 and 7 below, when elements emitting radiation were included, correct analysis results were not derived, and thus the iron oxide magnetic particles were produced by the same production method as the iron oxide magnetic particles of Example 1, but produced by replacing the radioactive isotope ¹³¹I with I, which commonly existed in nature.

### Experimental Example 6: Energy-Dispersive X-Ray Spectroscopy (EDS) Analysis

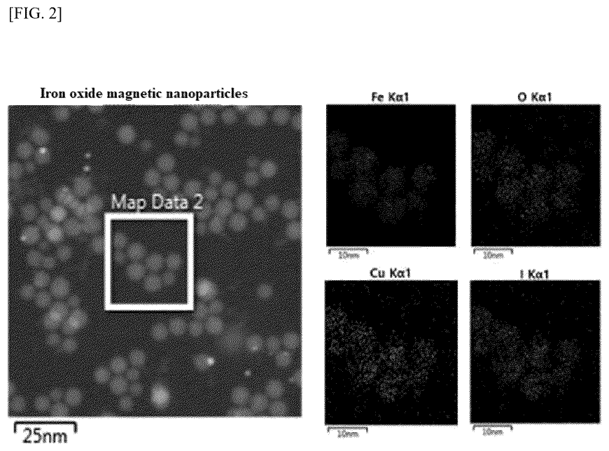

Using a JEM-2100F device from JEOL, iron oxide magnetic particles produced by the same method as in Example 1 and replacing the radioactive isotope ¹³¹I with I that commonly existed in nature were photographed, and the elements distributed in the iron oxide magnetic particles were confirmed. The results were shown in FIG. 2.

### Experimental Example 7: X-Ray Photoelectron Spectroscopy (XPS) Analysis

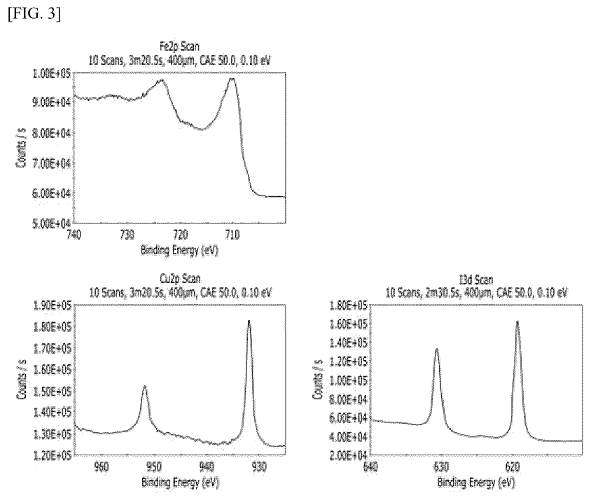

The bonding state of atoms existed on the surface of particles which were produced by the same method as Example 1, but produced by replacing the radioactive isotope ¹³¹I with I, which commonly existed in nature was confirmed by using a K-Alpha plus instrument of Thermo Fisher Scientific. The results were shown in FIG. 3.

1. A method for producing iron oxide magnetic particles comprising steps of:
synthesizing an iron precursor by mixing an iron salt, at least one fatty acid salt selected from the group consisting of fatty acid salts including fatty acid salts having 4 to 25 carbon atoms, and at least one alcohol selected from the group consisting of alcohols having 1 to 5 carbon atoms, and then heating and washing the mixture to form an iron fatty acid complex;
synthesizing iron oxide particles containing MX1n by mixing the synthesized iron precursor, MX1n, and at least one aliphatic alcohol selected from the group consisting of aliphatic alcohols having 6 to 25 carbon atoms, and heating the mixture; and forming the iron oxide magnetic particles containing the synthesized iron oxide particles and MX2n by mixing the synthesized iron oxide particles into a solution containing AX2n, and replacing the X1n and the X2n.

2. The method for producing iron oxide of magnetic particles of claim 1, wherein in the step synthesizing the iron oxide particles containing the MX1n, an unsaturated hydrocarbon having 6 to 20 carbon atoms is further included and mixed.

3. The method for producing iron oxide magnetic particles of claim 1, wherein in the step of synthesizing the iron precursor, the at least one fatty acid salt selected from the group consisting of fatty acid salts having 4 to 25 carbon atoms is oleate.

4. The method for producing iron oxide magnetic particles of claim 1, wherein in the step of synthesizing the iron oxide particles containing the MX1n, a weight ratio of the iron precursor and the MX1n is 1:0.001 to 0.1.

5. The method for producing iron oxide magnetic particles of claim 1, wherein the step of forming the iron oxide magnetic particles containing the iron oxide particles and the MX2n includes dispersing the iron oxide particles containing the MX1n in a hydrophobic solvent, and then adding and heating a solution containing the AX2n to a hydrophilic solvent as a solvent or irradiating the solution with a microwave to replace the X1n with the X2n.

6. The method for producing iron oxide magnetic particles of claim 1, wherein in the step of forming the iron oxide magnetic particles containing the iron oxide particles and the MX2n, the iron oxide magnetic particles are formed by further containing a hydrophilic coating compound and a targeting material.

7. The method for producing iron oxide magnetic particles of claim 6, wherein the forming of the iron oxide magnetic particles by further containing the hydrophilic coating compound and the targeting material is performed by mixing the hydrophilic coating compound and the targeting material simultaneously with heating or microwave irradiation when forming the iron oxide magnetic particles containing the iron oxide particles and the MX2n, or by mixing the hydrophilic coating compound and the targeting material after the heating or the microwave irradiation.

8. The method for producing iron oxide magnetic particles of claim 1, wherein the M includes at least one selected from the group consisting of Cu, Sn, Pb, Mn, Ir, Pt, Rh, Re, Ag, Au, Pd, Os, Ta, Yb, Zr, Hf, Tb, Tm, Ce, Dy, Er, Eu, Ho, Fe, La, Nd, Pr, Lu, Sc, Sr, Y, Sm, Bi, Ra, Ac, Th, At, Co, As, At, Ga, mTc and In, the X1 or the X2 includes at least one selected from the group consisting of F, Cl, Br, I, P, S, N and O, and the n is an integer of 1 to 6.

9. The method for producing iron oxide magnetic particles of claim 1, wherein the MX1n includes at least one selected from the group consisting of CuF, CuF2, CuF3, CuCl, and CuCl2, and the MX2n includes at least one selected from the group consisting of CuBr, CuBr2, CuI, CuI2, and CuI3.

10. Iron oxide magnetic particles formed by the production method of claim 9.

11. Iron oxide magnetic particles formed by the production method of claim 8.

12. Iron oxide magnetic particles formed by the production method of claim 7.

13. Iron oxide magnetic particles formed by the production method of claim 6.

14. Iron oxide magnetic particles formed by the production method of claim 5.

15. Iron oxide magnetic particles formed by the production method of claim 4.

16. Iron oxide magnetic particles formed by the production method of claim 3.

17. Iron oxide magnetic particles formed by the production method of claim 2.

18. Iron oxide magnetic particles formed by the production method of claim 1.
